(19) United States
(12) Patent Application Publication
(10) Pub. No.: US 2026/0266426 A1
(43) Pub. Date: Sep. 10, 2026

(54) LUBRICATION TANK

(71) Applicant: Caterpillar Global Mining LLC, Tucson, AZ (US)

(72) Inventors: Erik E. Knowles, Tucson, AZ (US); Christopher James Watson, Washington, IL (US); Sajin P. Koshy, Alleppey (IN)

(73) Assignee: Caterpillar Global Mining LLC, Tucson, AZ (US)

(21) Appl. No.: 19/069,626

(22) Filed: Mar. 4, 2025

(51) Int. Cl. F16N 7/38; F16N 19/00

(52) U.S. Cl. CPC F16N 7/38; F16N 19/00; F16N 2210/04

(57) ABSTRACT

A lubrication system for a work machine may include a lubrication tank having a lower section and an upper section, where the lower section has a cross-sectional area larger than the upper section defining a lower tank top. The lubrication system may also include a lubrication pump arranged outside the lubrication tank on the lower tank top and having a pickup tube extending into the lower section of the lubrication tank. The lubrication pump may be configured for connection to lubrication lines and for generating flow in the lubrication lines to deliver lubrication to one or more lubrication points of the work machine.

### TECHNICAL FIELD

The present application relates generally to equipment lubrication. More particularly, the present application relates to lubrication systems on work machines for lubricating bearings, joints, seals, or other features of the work machine. Still more particularly, the present application relates to a lubrication tank for an onboard grease system for a work machine.

### BACKGROUND

Work machines may include bearings, joints, seals and other features that use grease or other lubricants to improve performance and/or prolong the useful life of the respective feature. In some cases, grease zerks or fittings may be provided such that users, operators, or maintenance personnel may supply the machine feature with grease periodically such as on an as needed or scheduled basis. However, manual maintenance including greasing can be cumbersome, it can involve taking the machine out of service and can often lead to failure to maintain the work machine, which can lead to poor performance and/or premature failure of components. In some cases, onboard grease systems may be provided such that greasing of machine features can occur without taking the machine out of service.

Chinese Utility Model 212263157 relates to a grease lifting and pumping device for feed. Chinese Patent Application No. 115324682 relates to an engine oil cyclic regeneration system, control method and mining dump truck.

### SUMMARY

In one or more examples, a lubrication system for a work machine may include a lubrication tank having a lower section and an upper section, where the lower section has a cross-sectional area larger than the upper section defining a lower tank top. The lubrication system may also include a lubrication pump arranged outside the lubrication tank on the lower tank top and having a pickup tube extending into the lower section of the lubrication tank. The lubrication pump may be configured for connection to lubrication lines and for generating flow in the lubrication lines to deliver lubrication to one or more lubrication points of the work machine.

In one or more examples, a lubrication tank for a work machine may include a bottom, a lower section extending upward from the bottom to a lower tank top configured for placement of a lubrication pump thereon. The lower section may have a first cross-sectional area and the tank may include an upper section extending upward from the lower section and having a cross-sectional area smaller than the first cross-sectional area.

### DESCRIPTION OF THE DRAWINGS

FIG. 1A is a perspective view of a work machine having a lubrication tank, according to one or more examples.

FIG. 1B is a schematic diagram of lubrication pin locations for a backhoe type implement on the work machine, according to one or more examples.

FIG. 1C is a schematic diagram of a lubrication pin locations for a mining shovel type implement on the work machine, according to one or more examples.

FIG. 2 is a close-up view of the lubrication tank on the work machine with an outer housing removed, according to one or more examples.

FIG. 3 is a perspective view of the lubrication tank in isolation, according to one or more examples.

FIG. 4 is a cross-sectional view thereof.

FIG. 5A is a perspective view of another lubrication tank, according to one or more examples.

FIG. 5B is a perspective view of another lubrication tank, according to one or more examples.

FIG. 5C is a perspective view of still another lubrication tank, according to one or more examples.

FIG. 5D is a perspective view of still another lubrication tank, according to one or more examples.

### DETAILED DESCRIPTION

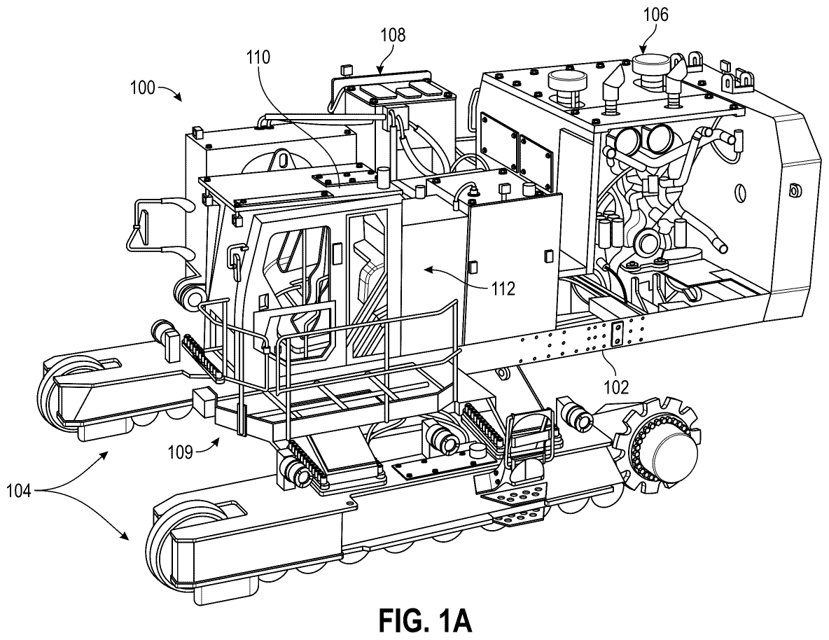

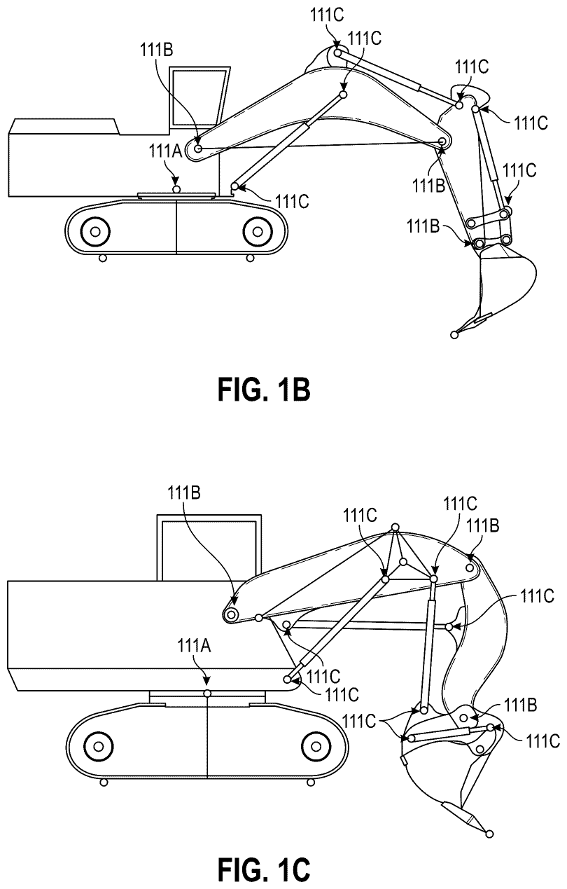

FIG. 1A is a perspective view of a work machine 100 such as a hydraulic mining shovel. The work machine 100 may include a frame 102, a ground engaging system 104 for supporting the frame 102 relative to a supporting surface such as the ground and for moving the work machine 100 across the supporting surface. The ground engaging 104 system may include a track system, for example, or a system of wheels and/or tires may be provided. The work machine 100 may also include a power source such as a gasoline-powered or diesel-powered combustion engine 106 or an electrical power supply (e.g., battery or electrical cord) and an electrical motor may be provided. The work machine 100 may include a hydraulic system 108 powered by the work machine power source 106 and configured to provide hydraulic power to one or more implements on the work machine. In the case of a mining shovel, the hydraulic system may be adapted to provide hydraulic power to inner and outer booms, and to a bucket or shovel. The hydraulic system 108 may also provide power to a turntable 109 or other system adapted to rotate a portion of the frame 102 relative to the grounding engaging system to allow the booms/shovel system, operator cabin 110, power source 106 etc. to be rotated about a vertical axis, for example. While a work machine 100 such as a mining shovel has been described, still other types of work machines may be provided including, for example, an excavator, a front-end loader, a dozer, a motor grader, large mining trucks, a cold planer, a rotary mixer, and other types of work machines.

With continued reference to FIG. 1A, the work machine 100 may include a lubrication system 112. That is, the several moving parts of the work machine 100 may include parts, features, or components that utilize lubrication to allow them to move relatively freely or with reduced friction and to perform well and/or for longer periods of time by reducing wear on the parts. As shown in FIGS. 1B and 1C, each of these parts, features, or components may include pins such as lubrication supply nipples or fittings. FIG. 1B shows an example of pin locations for a backhoe type implement on the work machine, while FIG. 1C shows an example of pin locations for a face shovel type implement. As shown, for example, the turntable 109 may include a slew ring that utilizes grease or other lubricant to allow one portion of the frame to rotate relative to another and one or more pins 111A may be provided to supply lubrication to the slew ring. In addition, the booms and bucket may be pivotally secured to one another at pivot pins or pivot joints. These pins/joints may utilize grease or other lubricant to allow for generally free pivoting motion of one boom relative to another and one or more pins 111B may be provided to supply lubrication to these pivot pins or joints. Still further, the hydraulic cylinders may be pivotally secured to the booms and the bucket at pivot pins or pivot joints, which may utilize grease or other lubricant to allow for generally free pivoting motion of the cylinders relative to the booms. Pins 111C may be provided to supply lubrication to these joints. Still other aspects of the work machine 100 may utilize grease or lubricant to assist in providing generally free or reduced friction movement including the track system 104, the suspension system, and other moving parts of the work machine some of which are shown in the attached figures.

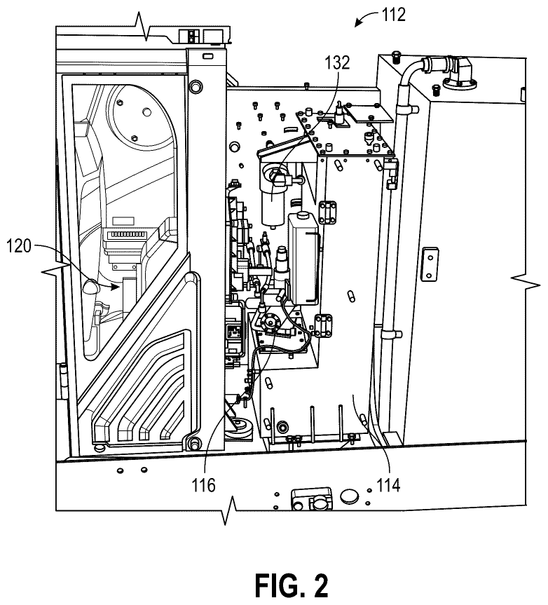

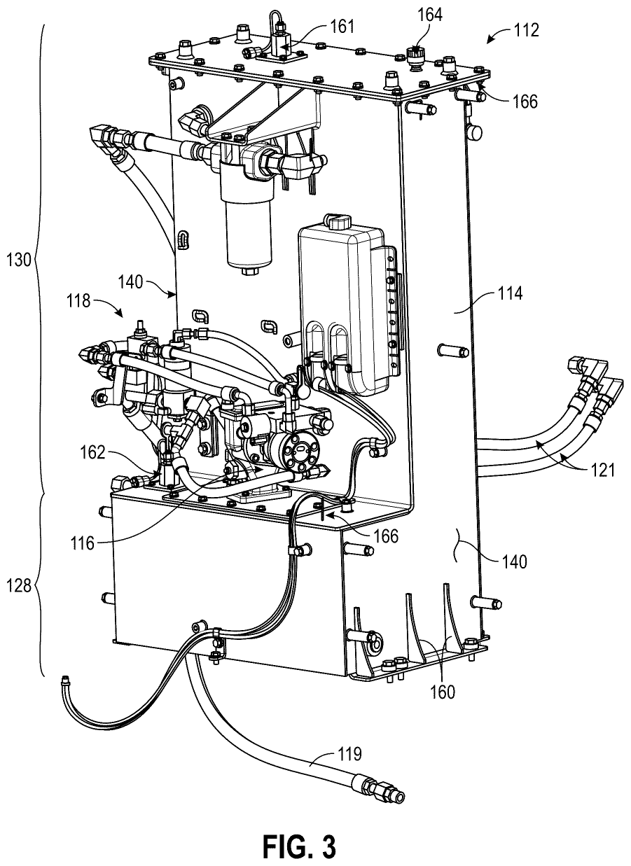

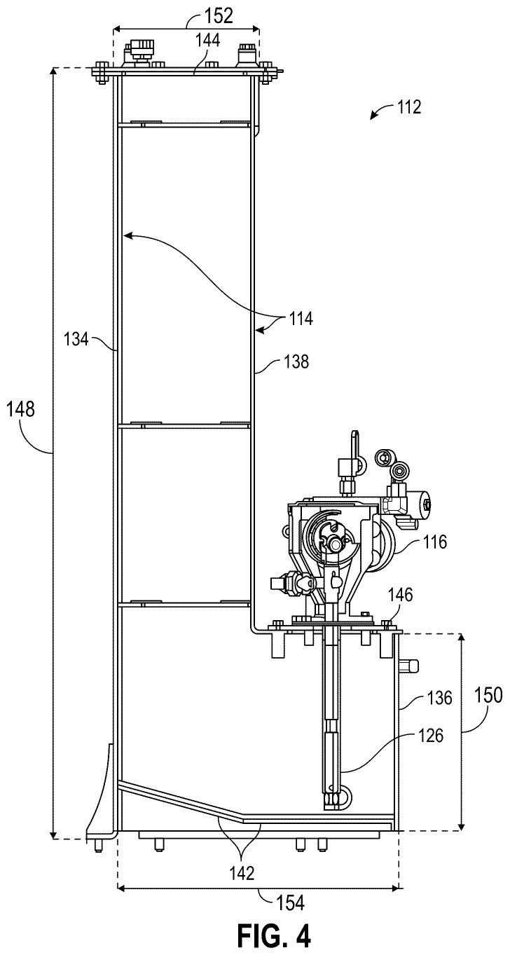

The lubrication system 112 may be configured to supply these several parts, features, or components with lubrication. As shown in FIGS. 1A and 2 and in more detail in FIGS. 3 and 4, the lubrication system 112 may include a lubrication tank 114, a lubrication pump 116, and a plurality of lubrication lines 118 extending from the pump 116 to one or more lubrication points on the work machine 100. The lubrication system 112 may also include a lubrication controller 120 configured to control the rate and amount of lubrication provided to the several lubrication points. In one or more examples, the controller 120 may be part and parcel to the electronic control module of the work machine 100. In other examples, a separate controller 120 may be provided. In either case, the lubrication controller 120 may be adapted to control the pump 116 to control the delivery of the lubrication to the lubrication points. In one or more examples, a series of injectors and/or manifolds may be provided throughout the system such that particular amounts of lubrication can be provided to particular lubrication points and/or at particular rates. In one or more examples, the lubrication controller 120 may be configured to provide lubrication to particular lubrication points by controlling the pump 116 and/or the injectors. In one or more examples, the lubrication controller 120 may be adapted to monitor use of the equipment and may supply lubrication based on the amount of use of the particular component at the respective lubrication point. In other examples, a more continuous or periodic supply of lubrication may be provided that is not based on the amount of use. Still other approaches to supplying lubrication to lubrication points may be provided. In one or more examples, the lubrication may be provided based on positive instruction from an operator. Still other approaches to supplying lubrication from the tank to the lubrication points may be provided.

The lubrication lines 118 may be configured to receive the lubrication from the lubrication pump 116 and deliver the lubrication to the one or more lubrication points (111A, 111B, 111C, etc.) on the work machine. The lubrication lines 118 may include trunk lines that carry lubrication to particular areas of the work machine 100 where the trunk line may branch into a larger number of same sized or smaller delivery lines. In one or more examples, the trunk line may provide lubrication to a manifold, which may provide for splitting the flow of the lubrication to the larger number of lines. In other examples, dedicated lubrication lines may be provided that extend from the pump 116 directly to a lubrication point on the work machine 100. In some examples, a manifold may be provided at or near the pump to divide the flow of lubrication immediately after or shortly after exiting the pump. Other lines such as a tank fill line 119 and hydraulic lines 121 for operating the pump 116 may also be provided.

The lubrication pump 116 may be configured for receiving lubrication from the lubrication tank 114 and for generating lubrication flow in the lubrication lines 118. In one or more examples, the pump 116 may be arranged at or near an outer surface of the lubrication tank 114 and may include a pickup tube 126 that may extend from the pump 116 into and within the lubrication tank 114. The pickup tube 126 may extend from the pump 116 to a location at or near the bottom of the lubrication tank 114. The lubrication pump 116 may be adapted for pumping relatively high viscous lubrication such as grease having a viscosity ranging from approximately 100 centistokes (cSt) to approximately 220 cSt, or from 130 cSt to approximately 170 cSt, or a viscosity of approximately 150 cSt may be used. Still further, the National Lubricating Grease Institute (NLGI) number of the greased used may range from Grade 0 to Grade 2 and may be Grade 1. The lubrication pump 116 may include a piston style pump or another pumps style may be used. The lubrication pump 116 may be distinguished from other pumps such as water pumps, hydraulic fluid/oil pumps, fuel pumps and the like. In particular, the lubrication pump 116 may be particularly adapted for the range of viscosities and grades mentioned.

The lubrication tank 114 may be configured to hold relatively large volumes of lubrication to allow the work machine 100 to be supplied with lubrication for extended periods of time without servicing or filling the tank 114. Still further, the lubrication tank 114 may be configured for supplying a pressure head that reduces the amount of work performed by the pump 116 when pumping fluid from the tank. As shown in FIG. 3, the lubrication tank 114 may include a lower section 128 and an upper section 130. In one or more examples, the upper section 130 may have a cross-sectional area, when viewed from above, that is smaller than the cross-sectional area of the lower section 128. In one or more examples, this may provide space within the overall footprint of the lubrication tank 114 for filters or other related or unrelated equipment. That is, as shown in FIG. 2, the lubrication tank 114 may be arranged behind the cabin or control station 110 of the work machine 100 and the smaller cross-sectional area of the upper portion 130 may allow for positioning of the lubrication pump 116, filters 132, hoses, and other equipment related or unrelated to the lubrication system 112 within a footprint of the lubrication tank.

In one particular example, as shown in FIGS. 3 and 4, the lubrication tank may be a generally L-shaped tank with a rectangular back wall 134, a lower rectangular front wall 136, an upper rectangular front wall 138, and two L-shaped sidewalls 140. A tank bottom 142 may be provided, and an upper tank top 144 and a lower tank top 146 may also be provided. In one or more examples, the lubrication tank 114 may have an overall height 148 and a height 150 of the lower section 128. In one or more examples, the height 150 of the lower section 128 may be relatively small compared to the overall height 148. That is, as shown, in one or more examples, the height 150 of the lower section 128 may range from approximately ⅙ to approximately ½ of the overall height 148, or the height 150 of the lower section 128 may range from approximately ⅕ to approximately ⅓ of the overall height 148, or the lower section 128 may have a height 150 of approximately ¼ of the overall height 148. In addition, the upper section 130 of the tank 114 may have a front-to-back depth 152 that is some fraction of the overall front-to-back depth 154. For example, the upper tank section 130 may have a depth 152 ranging from approximately ¾ to approximately ¼ of the overall depth 154 or a depth 152 ranging from approximately ⅔ to approximately ⅓ of the overall depth 154, or a depth 152 of approximately ½ of the overall depth 154 may be provided.

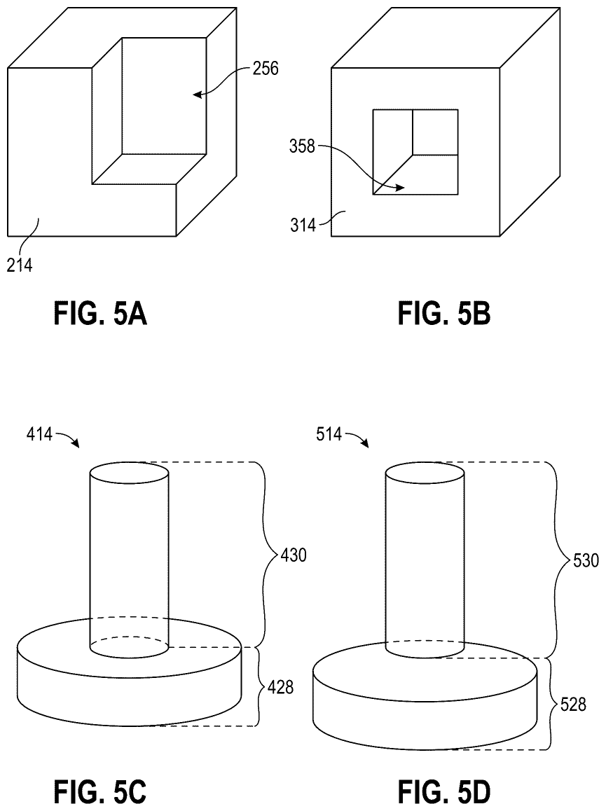

In one or more examples, alternative shapes may be provided where a location for the pump 116 is provided outside of the tank 114, but within the footprint of the tank 114 when viewed from above. For example, as shown in FIG. 5A, a vertically extending notch 256 may be provided in one quadrant of a rectangular tank 214 to provide a shelf for the pump to rest nearer to the bottom of the tank. FIG. 5B is another example showing a pocket cut out 358 of the tank 314 for placement of the pump nearer to the bottom of the tank 314. That is, some amount of tank volume may be provided along one or more sides of the pump and above the pump, while still providing for a pump location nearer to the bottom of the tank. In other examples as shown in FIGS. 5C and 5D, a cylindrical tank profile may be provided where an upper tank section 430/530 has a smaller diameter than a lower tank section 428/528 and, as such, a surface may be provided for locating the pump nearer to the bottom of the tank. In FIG. 5C, the upper tank section 430 may be generally concentric with the lower tank section 428 about a vertically extending longitudinal centerline. In FIG. 5D, and in contrast, the upper tank section 530 may be offset from a vertically extending longitudinal centerline of the lower tank section 528. In the end, and with reference to all of the examples provided, the cross-sectional area of the tank 114/214/314/414/514 when viewed from above, may be reduced at the location of the pump by an amount sufficient to locate all or most of the pump within a footprint of the tank and for a height to accommodate the height of the pump. However, the top of the tank may be at a location that is above the pump inlet. Moreover, the higher the top of the tank is relative to the pump inlet, the more pressure head the tank may provide to reduce the load on the pump when pumping the lubrication out of the tank.

In particular, it is to be appreciated that the upper section of the tank may provide for an increased pressure head to the pump located on the lower tank top as compared to systems where the pump is mounted at the top of the tank. That is, for example, while a lubricant pressure may be present at the bottom of the tank in all tanks, the pickup tube may lift the lubricant back to the top of the tank when the pump is positioned at the top. Here, the pump may be mounted on top of the lower section of the tank and, as such, the pump inlet may be at a much lower location and may benefit from the pressure head of the lubricant in the upper section.

In one or more examples, the geometry of the present lubrication tank may provide a positive pressure at the inlet of the pump. In some cases, when the tank is full, the positive pressure provided by the tank may be in the range of approximately 0.5 Hγ to approximately 0.83 Hγ, or approximately 0.67 Hγ to approximately 0.8 Hγ, or a positive pressure of approximately 0.75 Hγ may be provided, where H is the overall height of the tank and γ is the density of the lubricant. The fraction of the height that contributes to the pressure head at the pump may be the portion of the height above the lower section. For example, where the height of the lower section is ¼ of the overall height, then ¾ or 0.75 of the overall height may contribute to the positive pressure at the inlet of the pump. As the volume of lubricant in the tank decreases, the positive pressure provided may decrease, but the tank, nonetheless may allow for a positive pressure when the tank is full and throughout the emptying of the tank or until the top surface of the lubrication is at or below the height of the inlet on the pump. It is to be appreciated that frictional losses on the pressure head may be ignored due to the relatively broad cross-sectional area of the upper section. Where the cross-sectional area of the upper section is relatively small, the positive pressure at the pump may be slightly lower or reduced due to such frictional flow losses.

In one or more examples, the lubrication tank may be sized to hold approximately 175 liters to approximately 225 liters of grease, or approximately 185 liters to approximately 205 liters, or the tank may be sized to hold approximately 195 liters of grease. The tank size may be selected to provide for an air pocket when full and, as such, the tank may have an empty volume of approximately 185 liters to approximately 245 liters, or an empty volume of approximately 205 liters to approximately 225 liters, or an empty volume of approximately 215 liters may be provided. However, the tank size may be related to the machine the tank is being used to service. For example, larger hydraulic mining shovels may have a tank with a capacity of 1000 liters. Still further, trucks and motor graders may have a grease tank with a capacity closer to 50 liters. Still other tank sizes may be provided.

With reference to FIG. 4, in one or more examples, the tank bottom 142 may be configured to guide flow of the lubrication within the tank to the pump and/or the pump pickup tube. That is, as shown, the tank bottom 142 may be sloped to feed the lubrication toward the pump and/or the pickup tube of the pump. In one or more examples, the slope may extend from the back of the tank toward the front of the tank for a distance approximately equal to the depth 152 of the upper tank section 130. In other examples, the slope may extend into the front portion of the lower section of the tank and may approach the pickup tube location. In still other examples, the slope may extend the full back-to-front depth 154 of the lower section of the tank. While not shown, additional sloping may be provided from the sides of the tank toward a midline of the tank and/or a funnel-shaped bottom may be provided.

As shown in FIG. 3, the tank 114 may also include additional features such as a high-level sensor 161, a low-level sensor 162, and a breather 164, which may allow air to enter and exit the tank to maintain pressure equilibrium. Still further, seal gaskets 166 may be provided at the upper tank top 144 and the lower tank top 146 as well as at the sensors and the pump/tank interface.

It is to be appreciated that relatively high pressures may be present at or near the bottom of the tank, particularly when the tank is full or approximately full. To accommodate these pressures and maintain the surface profile of the tank, in some examples, the bottom of the tank may include a bottom plate that extends beyond the sidewalls of the tank and gusset plates 160 may be provided as shown, for example, in FIG. 3. Additional gusset plates and/or stiffeners may be provided within the tank as shown in FIG. 4. This may allow for a thinner plate to be used while still providing sufficient support for the lubrication held within the tank 114.

Still further, and as can be seen from a comparison of FIG. 1A to FIG. 2, an outer housing may be provided to surround the tank and the equipment arranged within its footprint. In one or more examples, standoffs may be provided for holding and supporting the outer housing at an offset distance from the outside surface of the tank. This may provide clearance for hoses or other equipment to pass around and/or by the tank while remaining within the outer housing. As shown in FIG. 4, the pump may be positioned on a top surface of the lower tank top. The pump may include a pickup tube that extends vertically through the lower tank top into the lower tank section to a location at or near the bottom of the tank. Still other pump arrangements may be provided.

### Industrial Applicability

The present lubrication tank may accommodate space claim issues associated with related or unrelated equipment while, at the same time, providing a reduced load on the lubrication pump due to its location closer to the bottom of the lubrication tank. That is, the upper section of the lubrication tank may have a reduced cross-sectional area as compared to the bottom section of the lubrication tank to accommodate the pump and/or other equipment that requires space on the work machine. The reduced cross-sectional area may create a shelf or lower tank top for placement of the lubrication pump. The location of the lubrication pump at a height lower than the overall top of the lubrication tank may create a pressure head that increases the pressure of the lubrication at the inlet of the lubrication pump and, as such, may assist in reducing the load on the pump when pumping the lubrication from the lubrication tank. This may allow for use of a relatively smaller pump and/or may contribute to increased longevity of the lubrication pump. Still further, the provision of an upper section may reduce the tendency for a conical void to form around the base of the pickup tube. That is, the increased pressure above the lower section may help to maintain the lower section full of lubricant as the lubricant is drawn out of the tank and, as such, may reduce “drawing down” of the lubrication at or near the base of the pickup tube. While a generally L-shaped tank has been shown, multiple configurations may be envisaged that accommodate locating the pump at a height lower than the overall top of the tank while also accommodating the space claim issues of related or unrelated equipment.

The above detailed description is intended to be illustrative, and not restrictive. The scope of the disclosure should, therefore, be determined with references to the appended claims, along with the full scope of equivalents to which such claims are entitled.

1. A lubrication system for a work machine, the lubrication system comprising:
a lubrication tank having a lower section and an upper section, where the lower section has a cross-sectional area larger than the upper section thereby defining a lower tank top; and
a lubrication pump arranged outside the lubrication tank on the lower tank top and having a pickup tube extending into the lower section of the lubrication tank, the lubrication pump being configured for connection to lubrication lines and for generating flow in the lubrication lines to deliver lubrication to one or more lubrication points of the work machine,
wherein the lubrication pump has an inlet, the lubrication has a density, γ, and the lubrication tank has an overall height. H. the lubrication tank allowing for a positive pressure at the inlet of the pump of approximately 0.75 Hγ.

2-3. (canceled)

4. The lubrication system of claim 1, wherein the upper section has a rectangular cross-section and the lower section has a rectangular cross-section.

5. The lubrication system of claim 4, wherein the lubrication tank has a rectangular back wall, a lower front wall, an upper front wall, and two L-shaped sidewalls.

6. The lubrication system of claim 5, wherein the lubrication tank comprises a bottom and an upper tank top.

7. The lubrication system of claim 6, wherein the bottom is sloped.

8. The lubrication system of claim 1, further comprising the lubrication lines.

9. The lubrication system of claim 1, further comprising a lubrication controller configured to control the lubrication pump to deliver lubrication to the lubrication points.

10. The lubrication system of claim 9, wherein the controller is configured to control the lubrication pump to deliver lubrication based on an amount of use of the lubricated components.

11. The lubrication system of claim 9, wherein the controller is configured to control the lubrication pump to deliver lubrication periodically.

12. The lubrication system of claim 9, further comprising injectors operable by the lubrication controller to control the delivery of lubrication to the lubrication points.

13. The lubrication system of claim 12, further comprising manifolds configured to divide the flow of lubrication.

14. A lubrication tank for a work machine, the lubrication tank comprising:
a bottom;
a lower section extending upward from the bottom to a lower tank top configured for placement of a lubrication pump thereon, the lower section having a first cross-sectional area;
an upper section extending upward from the lower section and having a cross-sectional area smaller than the first cross-sectional area,
wherein the lower section and the upper section combine to define an overall height and the lower section has a height of approximately ¼ of the overall height.

15-16. (canceled)

17. The lubrication tank of claim 14, wherein the lower section has a rectangular cross section and the upper section has a rectangular cross section.

18. The lubrication tank of claim 17, wherein the upper section and the lower section are defined by a full height back wall.

19. The lubrication tank of claim 18, further comprising an upper front wall and a lower front wall.

20. The lubrication tank of claim 19, further comprising a pair of opposing L-shaped sidewalls.

21. The lubrication tank of claim 20, wherein the bottom is sloped.
